(19) United States
(12) Patent Application Publication
(10) Pub. No.: US 2026/0058399 A1
(43) Pub. Date: Feb. 26, 2026

(54) FIRST TERMINAL MODULE, FIRST ELECTRICAL CONNECTOR AND CONNECTOR ASSEMBLY WITH IMPROVED INSULATING BLOCK

(71) Applicant: DONGGUAN LUXSHARE TECHNOLOGIES CO., LTD, Dongguan City (CN)

(72) Inventors: Tao SONG, Dongguan City (CN); Kun LIU, Dongguan City (CN); Xiaoping WU, Dongguan City (CN)

(73) Assignee: DONGGUAN LUXSHARE TECHNOLOGIES CO., LTD, Dongguan City (CN)

(21) Appl. No.: 18/895,023

(22) Filed: Sep. 24, 2024

(30) Foreign Application Priority Data
Aug. 26, 2024 (CN) 202411181445.4

(51) Int. Cl. H01R 13/502; H01R 12/71; H01R 13/02; H01R 13/6581

(52) U.S. Cl. CPC H01R 13/502; H01R 12/716; H01R 13/02; H01R 13/6581

(57) ABSTRACT

A first terminal module includes a first insulating block and a first terminal group. The first insulating block includes a first protruding post and a second protruding post disposed oppositely. The first terminal group includes a first conductive terminal and a second conductive terminal. The first conductive terminal includes a first contact portion. The second conductive terminal includes a second contact portion. A structural strength of the first insulating block by providing the first protruding post and the second protruding post is improved. A first electrical connector having the first terminal module and a connector assembly having the first electrical connector are also disclosed.

### CROSS-REFERENCE TO RELATED APPLICATION

This patent application claims priority of a Chinese Patent Application No. 202411181445.4, filed on Aug. 26, 2024 and titled “FIRST TERMINAL MODULE, FIRST ELECTRICAL CONNECTOR AND CONNECTOR ASSEMBLY”, the entire content of which is incorporated herein by reference.

### TECHNICAL FIELD

The present disclosure relates to a first terminal module, a first electrical connector and a connector assembly thereof, which belongs to the technical field of connectors.

### BACKGROUND

Connector assemblies in the related art generally include a first electrical connector and a second electrical connector for mating with each other. The first electrical connector generally includes a first insulating body and a plurality of first conductive terminals fixed to the first insulating body. The second electrical connector generally includes a second insulating body and a plurality of second conductive terminals fixed to the second insulating body. When the first electrical connector and the second electrical connector are mated, the first conductive terminal and the second conductive terminal contact each other to achieve electrical connection.

However, as the signal transmission requirements of electrical connectors continue to increase, there is still room for improvement in electrical connectors and electrical connector assemblies in related technologies.

### SUMMARY

An object of the present disclosure is to provide a first terminal module, a first electrical connector and a connector assembly with improved structures.

In order to achieve the above object, the present disclosure adopts the following technical solution: a first terminal module, including: a first insulating block, the first insulating block including a first protruding post and a second protruding post; the first protruding post and the second protruding post being disposed oppositely; the first protruding post being sector-shaped and defining a first opening; the second protruding post being sector-shaped and defining a second opening; and a first terminal group, the first terminal group being provided on the first insulating block; the first terminal group including a first conductive terminal and a second conductive terminal; the first conductive terminal including a first elastic arm at least partially provided in the first opening; the first elastic arm including a first contact portion; the second conductive terminal including a second elastic arm at least partially provided in the second opening; the second elastic arm including a second contact portion; the first contact portion and the second contact portion being offset from each other.

In order to achieve the above object, the present disclosure adopts the following technical solution: a first electrical connector, including: a first insulating body, the first insulating body including a first base portion and a plurality of first wall portions protruding from the first base portion; the first base portion and the plurality of first wall portions jointly forming a first receiving space; and a plurality of first terminal modules, the plurality of first terminal modules being installed to the first base portion; each first terminal module including a first insulating block, a first terminal group provided in the first insulating block, a first shielding sleeve sleeved on the first insulating block, and a first receiving cavity located between the first insulating block and the first shielding sleeve; wherein the first insulating block includes a first protruding post and a second protruding post; the first protruding post and the second protruding post are disposed oppositely; the first receiving cavity includes a first mating cavity located on one side of the first protruding post and the second protruding post, and a second mating cavity located on another side of the first protruding post and the second protruding post; the first terminal group includes a first conductive terminal and a second conductive terminal; the first conductive terminal includes a first fixing portion fixed to the first insulating block, a first elastic arm extending from the first fixing portion and a first mounting portion extending from the first fixing portion; the first elastic arm includes a first contact portion protruding into the first mating cavity; the second conductive terminal includes a second fixing portion fixed to the first insulating block, a second elastic arm extending from the second fixing portion and a second mounting portion extending from the second fixing portion; the second elastic arm includes a second contact portion protruding into the second mating cavity.

In order to achieve the above object, the present disclosure adopts the following technical solution: a connector assembly, including: a first electrical connector; the first electrical connector, including: a first insulating body, the first insulating body including a first base portion and a plurality of first wall portions; the first base portion and the plurality of first wall portions jointly forming a first receiving space; and a plurality of first terminal modules, the plurality of first terminal modules being installed to the first base portion; each first terminal module including a first insulating block, a first terminal group fixed to the first insulating block, a first shielding sleeve sleeved on the first insulating block, and a first receiving cavity located between the first insulating block and the first shielding sleeve; wherein the first insulating block includes a first protruding post and a second protruding post; the first protruding post and the second protruding post are disposed oppositely; the first receiving cavity includes a first mating cavity located on one side of the first protruding post and the second protruding post, and a second mating cavity located on another side of the first protruding post and the second protruding post; the first terminal group includes a first conductive terminal and a second conductive terminal; the first conductive terminal includes a first fixing portion fixed in the first insulating block, a first elastic arm and a first mounting portion; the first elastic arm includes a first contact portion protruding into the first mating cavity; the second conductive terminal includes a second fixing portion fixed in the first insulating block, a second elastic arm and a second mounting portion; the second elastic arm includes a second contact portion protruding into the second mating cavity; and a second electrical connector configured to mate with the first electrical connector; the first electrical connector and the second electrical connector having same structures, but different installation angles.

Compared with the prior art, the first terminal module of the present disclosure includes the first insulating block. The first insulating block includes the first protruding post and the second protruding post. The first protruding post and the second protruding post are disposed oppositely. By providing the first protruding post and the second protruding post, the structural strength of the first insulating block is increased.

### BRIEF DESCRIPTION OF DRAWINGS

FIG. 1 is a perspective schematic view of a connector assembly in accordance with an embodiment of the present disclosure;

FIG. 2 is a perspective view of FIG. 1 from another angle;

FIG. 3 is a partially exploded perspective view of FIG. 1;

FIG. 4 is a further partially exploded perspective view of FIG. 3;

FIG. 5 is a partially exploded perspective view of FIG. 4 from another angle;

FIG. 6 is a top view of a first electrical connector in FIG. 3;

FIG. 7 is a bottom view of FIG. 6;

FIG. 8 is a partially exploded perspective view of the first electrical connector in FIG. 3;

FIG. 9 is a partially exploded perspective view of FIG. 8 from another angle;

FIG. 10 is a partially exploded perspective view of the first terminal module in FIG. 8;

FIG. 11 is a partially exploded perspective view of FIG. 10 from another angle;

FIG. 12 is a further exploded perspective view of FIG. 10;

FIG. 13 is an exploded perspective view of FIG. 12 from another angle;

FIG. 14 is a partial enlarged view of frame portion B in FIG. 6;

FIG. 15 is a partial enlarged view of frame portion C in FIG. 7;

FIG. 16 is a bottom view of a second electrical connector in FIG. 4;

FIG. 17 is a top view of FIG. 16;

FIG. 18 is a partially exploded perspective view of the second electrical connector;

FIG. 19 is a partially exploded perspective view of FIG. 18 from another angle;

FIG. 20 is a partially exploded perspective view of a first terminal module in FIG. 18;

FIG. 21 is a partially exploded perspective view of FIG. 20 from another angle;

FIG. 22 is a further exploded perspective view of FIG. 20;

FIG. 23 is an exploded perspective view of FIG. 22 from another angle;

FIG. 24 is a partial enlarged view of frame portion D in FIG. 16; and

FIG. 25 is a partially enlarged view of frame portion E in FIG. 17.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

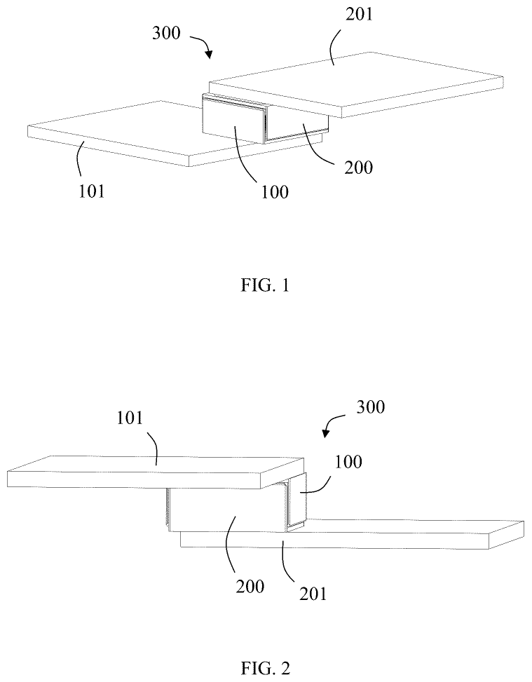

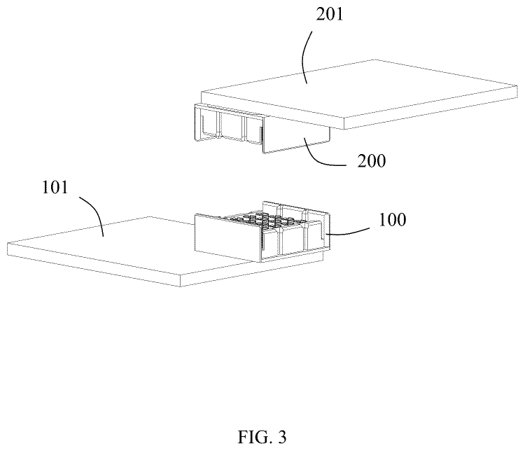

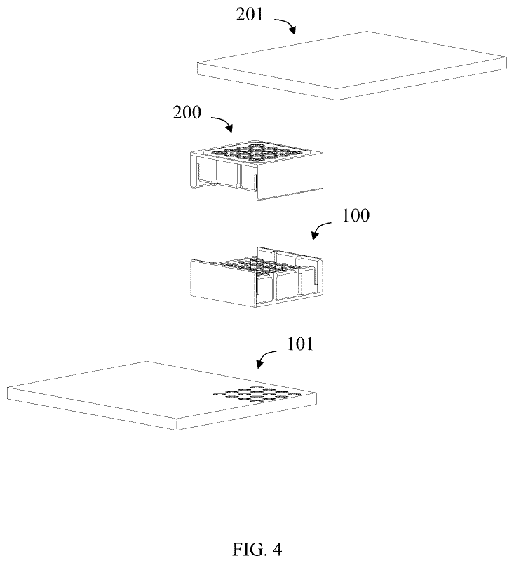

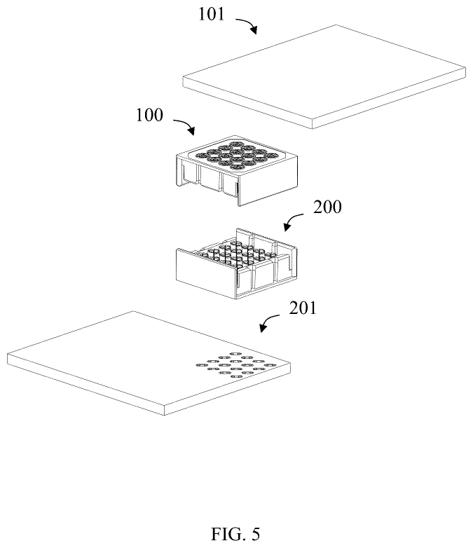

Referring to FIG. 1 to FIG. 5, the present disclosure discloses a connector assembly 300, which includes a first circuit board 101, a first electrical connector 100 installed on the first circuit board 101, a second circuit board 201, and a second electrical connector 200 installed on the second circuit board 201. In an illustrated embodiment of the present disclosure, the first electrical connector 100 is mounted on the first circuit board 101 by Surface Mounting Technology (SMT). The second electrical connector 200 is mounted on the second circuit board 201 by Surface Mounting Technology (SMT). In the illustrated embodiment of the present disclosure, the first electrical connector 100 and the second electrical connector 200 are mated with each other. The second electrical connector 200 and the first electrical connector 100 have same structures, but different installation angles, in order to maximize the sharing of parts and reduce costs. In the illustrated embodiment of the present disclosure, the second electrical connector 200 is formed by flipping the first electrical connector 100 by 180 degrees along a vertical plane and rotating by 90 degrees along a horizontal plane.

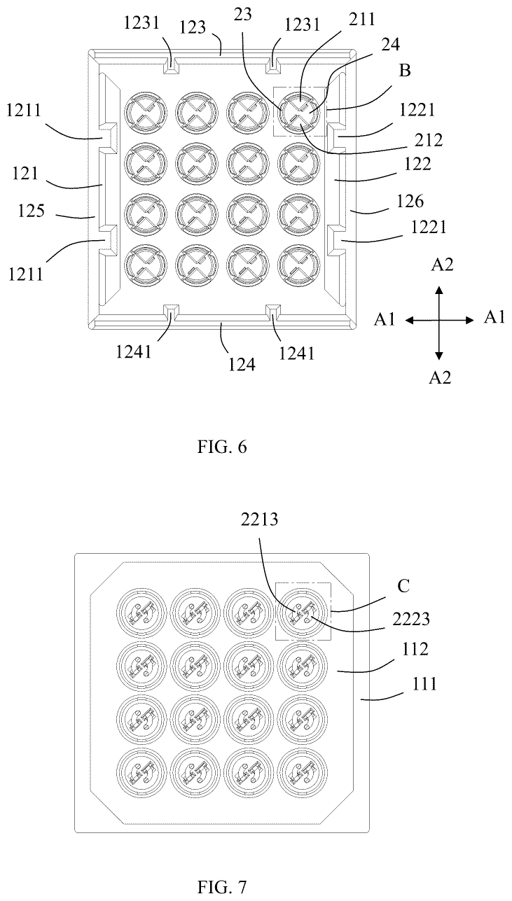

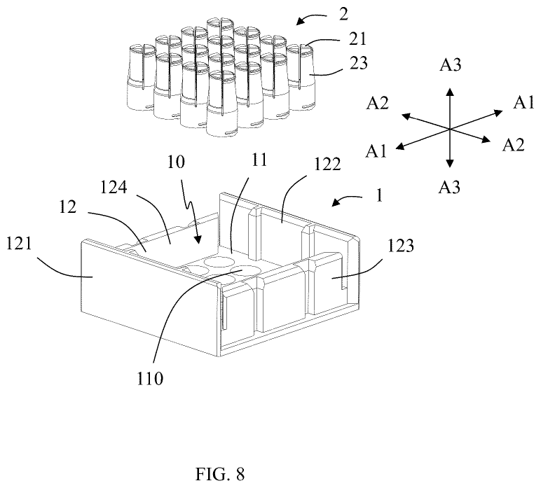

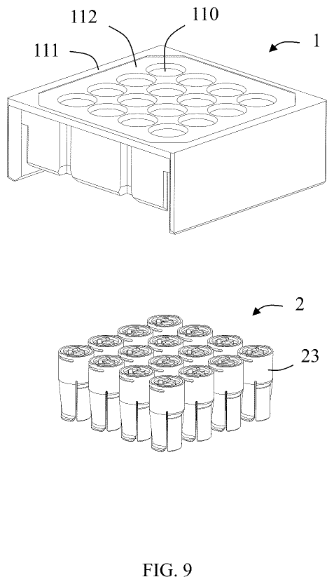

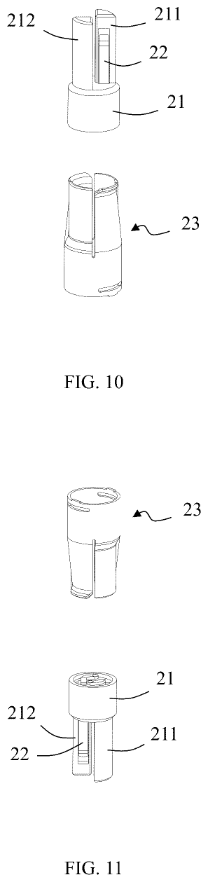

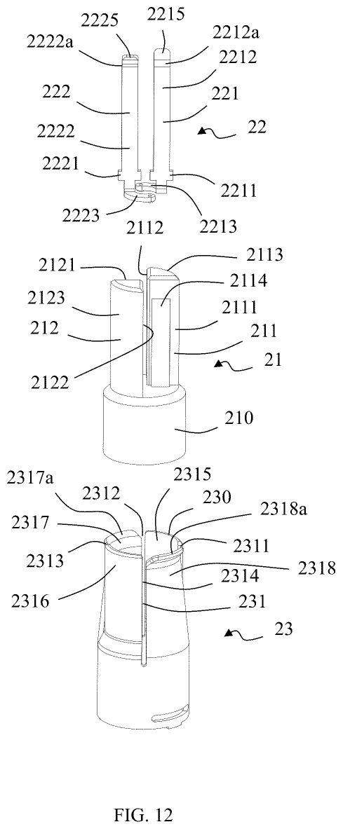

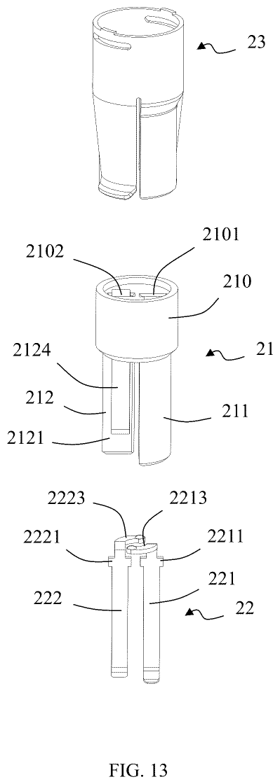

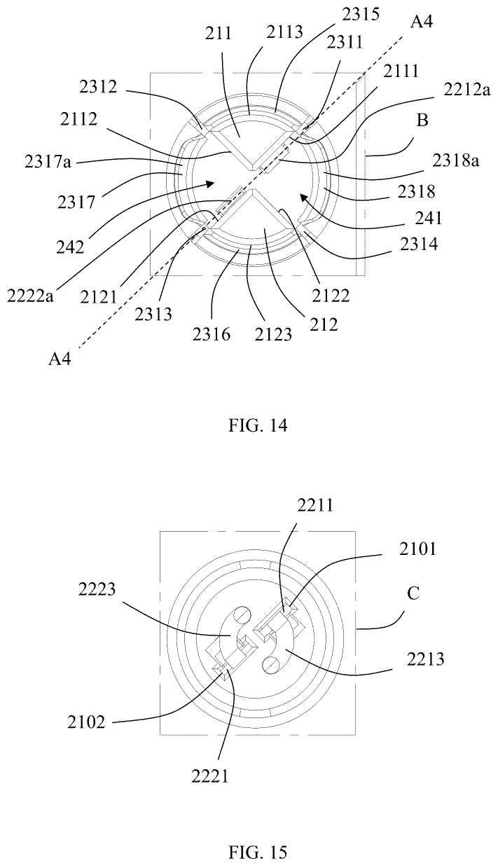

Referring to FIG. 6 to FIG. 9, in the illustrated embodiment of the present disclosure, the first electrical connector 100 includes a first insulating body 1 and a plurality of first terminal modules 2.

In the illustrated embodiment of the present disclosure, the first insulating body 1 includes a first base portion 11 and a plurality of first wall portions 12 protruding from the first base portion 11. The first base portion 11 and the first wall portions 12 jointly form a first receiving space 10. The first base portion 11 defines a plurality of first terminal mounting holes 110. The first terminal module 2 is assembled and fixed in a corresponding first terminal mounting hole 110.

In the illustrated embodiment of the present disclosure, the plurality of first wall portions 12 include first side wall 121, a second side wall 122, a third side wall 123 and a fourth side wall 124. The first side wall 121 and the second side wall 122 are disposed face to face along a first direction A1-A1 (for example, a left-right direction). The third side wall 123 and the fourth side wall 124 are disposed face to face along a second direction A2-A2 (for example, a front-rear direction). The first direction A1-A1 and the second direction A2-A2 are perpendicular to each other.

As shown in FIG. 6, the first insulating body 1 includes a first receiving groove 125 located outside the first side wall 121 and a second receiving groove 126 located outside the second side wall 122. A first keyway 1211 is provided on the outside of the first side wall 121 and communicates with the first receiving groove 125. An outer surface of the first side wall 121 defines a first keyway 1211 communicating with the first receiving groove 125. An outer surface of the second side wall 122 defines a second keyway 1221 communicating with the second receiving groove 126. The third side wall 123 includes a first rib 1231 protruding into the first receiving space 10. The fourth side wall 124 includes a second rib 1241 protruding into the first receiving space 10. In the illustrated embodiment of the present disclosure, the first side wall 121 and the second side wall 122 are symmetrically disposed on two sides of the first receiving space 10, respectively. The third side wall 123 and the fourth side wall 124 are symmetrically disposed on another two sides of the first receiving space 10, respectively.

The first base portion 11 includes a first mounting surface 111 and a first recessed portion 112 recessed from the first mounting surface 111. The plurality of first terminal mounting holes 110 extend through the first base portion 11 along a third direction A3-A3 (for example, a top-bottom direction). The third direction A3-A3 is perpendicular to the first direction A1-A1 and the second direction A2-A2.

In the illustrated embodiment of the present disclosure, the plurality of first terminal modules 2 are installed in a matrix on the first base portion 11. The plurality of first terminal modules 2 are arranged in a plurality of rows and a plurality of columns along the first direction A1-A1 and the second direction A2-A2.

In the illustrated embodiment of the present disclosure, each first terminal module 2 is the same and includes a first insulating block 21, a first terminal group 22 provided in the first insulating block 21, a first shielding sleeve 23 sleeved on the first insulating block 21, and a first receiving cavity 24 located between the first insulating block 21 and the first shielding sleeve 23.

The first insulating block 21 includes a first base 210, a first protruding post 211 protruding from the first base 210, and a second protruding post 212 protruding from the first base 210. The first protruding post 211 and the second protruding post 212 are disposed face to face and arranged side by side.

The first base 210 defines a first mounting groove 2101 and a second mounting groove 2102.

The first receiving cavity 24 includes a first mating cavity 241 located on one side (for example, a left side) of the first protruding post 211 and the second protruding post 212, and a second mating cavity 242 located on another side (for example, a right side) of the first protruding post 211 and the second protruding post 212.

In the illustrated embodiment of the present disclosure, the first protruding post 211 is sector-shaped. The first protruding post 211 includes a first side surface 2111, a second side surface 2112 perpendicular to the first side surface 2111, a first arc surface 2113 connecting the first side surface 2111 and the second side surface 2112, and a first opening 2114 extending through the first side surface 2111 and communicating with the first mating cavity 241.

Similarly, the second protruding post 212 is sector-shaped. The second protruding post 212 includes a third side surface 2121, a fourth side surface 2122 perpendicular to the third side surface 2121, a second arc surface 2123 connecting the third side surface 2121 and the fourth side surface 2122, and a second opening 2124 extending through the third side surface 2121 and communicating with the second mating cavity 242. The first protruding post 211 and the second protruding post 212 are disposed face to face and arranged at intervals along the second direction A2-A2.

The first terminal group 22 includes a first conductive terminal 221 and a second conductive terminal 222. In an embodiment of the present disclosure, the first conductive terminal 221 and the second conductive terminal 222 form a differential pair. The first conductive terminal 221 includes a first fixing portion 2211 fixed to the first insulating block 21, a first elastic arm 2212 extending from the first fixing portion 2211 and a first mounting portion 2213 extending from the first fixing portion 2211. The first elastic arm 2212 is located in the first opening 2114. The first elastic arm 2212 is provided with a first contact portion 2212a that protrudes into the first mating cavity 241 of the first receiving cavity 24. In the illustrated embodiment of the present disclosure, the first fixing portion 2211 is fixed in the first mounting groove 2101.

The second conductive terminal 222 includes a second fixing portion 2221 fixed to the first insulating block 21, a second elastic arm 2222 extending from the second fixing portion 2221 and a second mounting portion 2223 extending from the second fixing portion 2221. The second elastic arm 2222 is located in the second opening 2124. The second elastic arm 2222 is provided with a second contact portion 2222a that protrudes into the second mating cavity 242 of the first receiving cavity 24. In the illustrated embodiment of the present disclosure, the second fixing portion 2221 is fixed in the second mounting groove 2102.

In the illustrated embodiment of the disclosure, the first contact portion 2212a and the second contact portion 2222a are offset from each other. The first side surface 2111 and the third side surface 2121 are distributed along a fourth direction A4-A4. The fourth direction A4-A4 is disposed obliquely with respect to the first direction A1-A1 and the second direction A2-A2.

In addition, in the illustrated embodiment of the present disclosure, the first conductive terminal 221 includes a first bent end 2215 bent outwardly from the first contact portion 2212a. The second conductive terminal 222 includes a second bent end 2225 bent outwardly from the second contact portion 2222a. The first bent end 2215 and the second bent end 2225 have opposite bending directions.

In the illustrated embodiment of the present disclosure, the first mounting portion 2213 and the second mounting portion 2223 are both arc-shaped and extend in a clockwise or counterclockwise direction.

The first shielding sleeve 23 protrudes into the first receiving space 10. The first shielding sleeve 23 includes a first end portion 230 and a plurality of first slits 231 extending through the first end portion 230. The plurality of first slits 231 are distributed along a circumferential direction of the first shielding sleeve 23.

Specifically, in the illustrated embodiment of the present disclosure, the plurality of first slits 231 include a first slit 2311, a second slit 2312, a third slit 2313 and a fourth slit 2314 which are distributed along the circumferential direction of the first shielding sleeve 23 in sequence. The first shielding sleeve 23 includes a first arc-shaped wall 2315 located between the first slit 2311 and the second slit 2312, a second arc-shaped wall 2316 located between the third slit 2313 and the fourth slit 2314, a third arc-shaped wall 2317 located between the first slit 2311 and the fourth slit 2314, and a fourth arc-shaped wall 2318 located between the second slit 2312 and the third slit 2313. The first arc surface 2113 of the first protruding post 211 contacts an inner side of the first arc-shaped wall 2315. The second arc surface 2123 of the second protruding post 212 contacts an inner side of the second arc-shaped wall 2316. The third arc-shaped wall 2317 is exposed in the first mating cavity 241. The fourth arc-shaped wall 2318 is exposed in the second mating cavity 242. The third arc-shaped wall 2317 includes a first outward flange portion 2317a located at a free end of the third arc-shaped wall 2317. The fourth arc-shaped wall 2318 includes a second outward flange portion 2318a located at a free end of the fourth arc-shaped wall 2318.

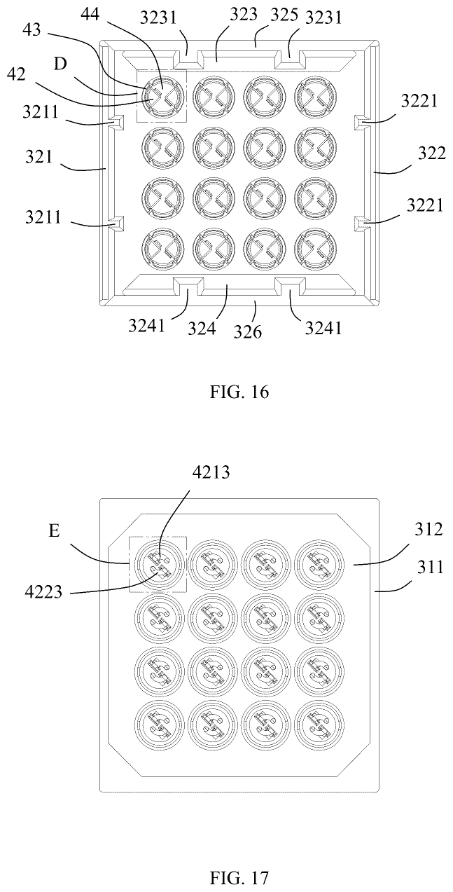

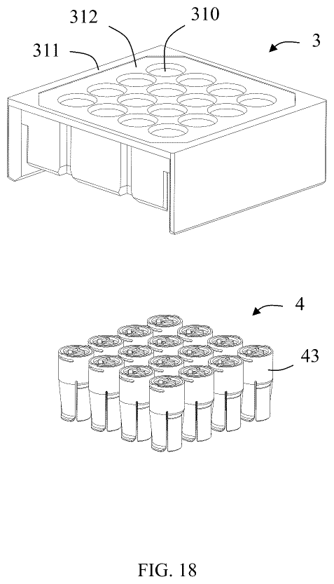

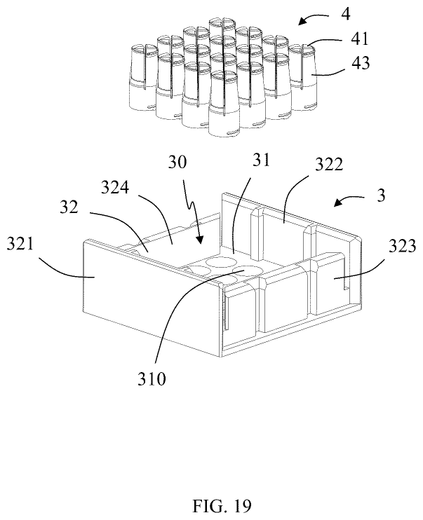

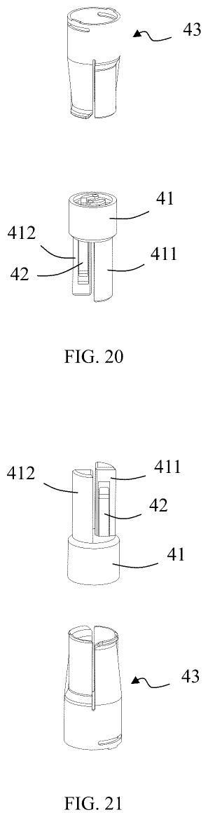

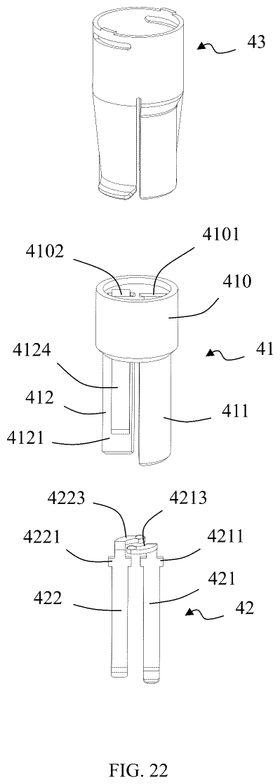

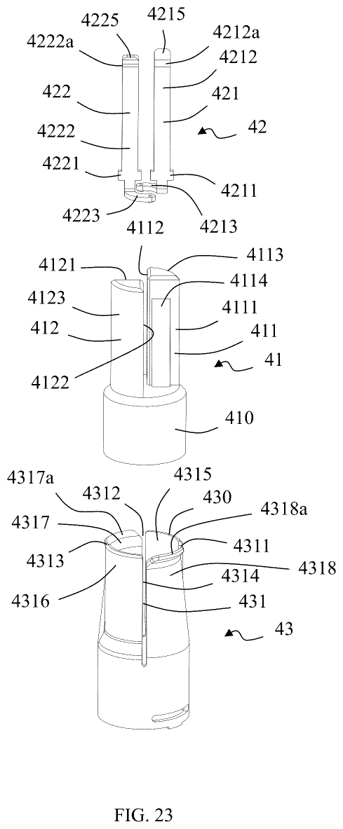

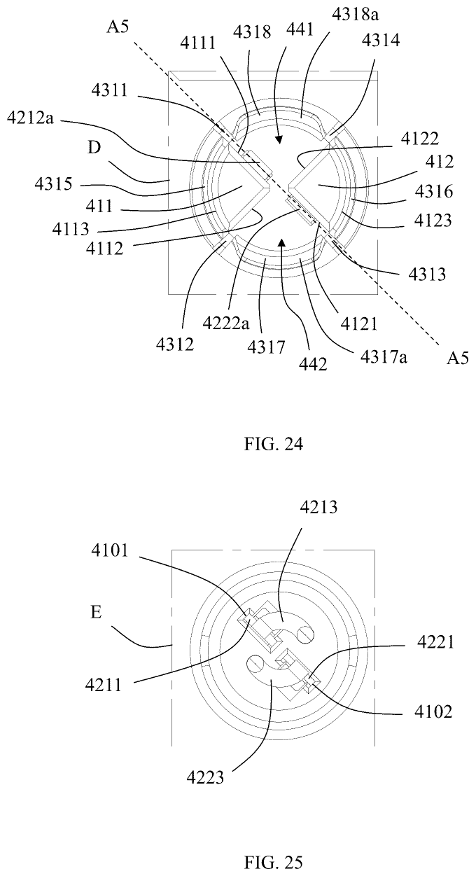

Referring to FIG. 16 to FIG. 25, in the illustrated embodiment of the present disclosure, the second electrical connector 200 includes a second insulating body 3 and a plurality of second terminal modules 4.

In the illustrated embodiment of the present disclosure, the second insulating body 3 includes a second base portion 31 and a plurality of second wall portions 32 protruding from the second base portion 31. The second base portion 31 and the plurality of second wall portions 32 jointly form a second receiving space 30. The second base portion 31 defines a plurality of second terminal mounting holes 310. The second terminal module 4 is assembled and fixed in a corresponding second terminal mounting hole 310.

In the illustrated embodiment of the present disclosure, the plurality of second wall portions 32 include a fifth side walls 321, a sixth side wall 322, a seventh side wall 323 and an eighth side wall 324. The fifth side wall 321 and the sixth side wall 322 are disposed face to face. The seventh side wall 323 and the eighth side wall 324 are disposed face to face.

The second insulating body 3 includes a third receiving groove 325 located outside the seventh side wall 323 and a fourth receiving groove 326 located outside the eighth side wall 324. An outer surface of the seventh side wall 323 defines a third keyway 3231 communicating with the third receiving groove 325. An outer surface of the eighth side wall 324 defines a fourth keyway 3241 communicating with the fourth receiving groove 326. The fifth side wall 321 includes a third rib 3211 protruding into the second receiving space 30. The sixth side wall 322 includes a fourth rib 3221 protruding into the second receiving space 30. In the illustrated embodiment of the present disclosure, the fifth side wall 321 and the sixth side wall 322 are symmetrically disposed on two sides of the second receiving space 30, respectively. The seventh side wall 323 and the eighth side wall 324 are symmetrically disposed on another two sides of the second receiving space 30, respectively.

The second base portion 31 includes a second mounting surface 311 and a second recessed portion 312 recessed from the second mounting surface 311. The plurality of second terminal mounting holes 310 extend through the second base portion 31 along the third direction A3-A3.

In the illustrated embodiment of the present disclosure, the plurality of second terminal modules 4 are installed in a matrix on the second base portion 31. The plurality of second terminal modules 4 are arranged in a plurality of rows and a plurality of columns along the first direction A1-A1 and the second direction A2-A2.

In the illustrated embodiment of the present disclosure, each second terminal module 4 is the same and includes a second insulating block 41, a second terminal group 42 provided in the second insulating block 41, a second shielding sleeve 43 sleeved on the second insulating block 41, and a second receiving cavity 44 located between the second insulating block 41 and the second shielding sleeve 43.

The second insulating block 41 includes a second base 410, a third protruding post 411 protruding from the second base 410 and a fourth protruding post 412 protruding from the second base 410. The third protruding post 411 and the fourth protruding post 412 are disposed face to face and arranged side by side.

The second base 410 includes a third mounting groove 4101 and a fourth mounting groove 4102.

The second receiving cavity 44 includes a third mating cavity 441 located on one side of the third protruding post 411 and the fourth protruding post 412, and a fourth mating cavity 442 located on another side of the third protruding post 411 and the fourth protruding post 412.

In the illustrated embodiment of the disclosure, the third protruding post 411 is sector-shaped. The third protruding post 411 includes a fifth side surface 4111, a sixth side surface 4112 perpendicular to the fifth side surface 4111, a third arc surface 4113 connecting the fifth side surface 4111 and the sixth side surface 4112, and a third opening 4114 extending through the fifth side surface 4111 and communicating with the third mating cavity 441.

Similarly, the fourth protruding post 412 is sector-shaped. The fourth protruding post 412 includes a seventh side surface 4121, an eighth side surface 4122 perpendicular to the seventh side surface 4121, a fourth arc surface 4123 connecting the seventh side surface 4121 and the eighth side surface 4122, and a fourth opening 4124 extending through the seventh side surface 4121 and communicating with the fourth mating cavity 442. The third protruding post 411 and the fourth protruding post 412 are disposed face to face and arranged at intervals.

The second terminal group 42 includes a third conductive terminal 421 and a fourth conductive terminal 422. In an embodiment of the present disclosure, the third conductive terminal 421 and the fourth conductive terminal 422 form a differential pair. The third conductive terminal 421 includes a third fixing portion 4211 fixed to the second insulating block 41, a third elastic arm 4212 extending from the third fixing portion 4211 and a third mounting portion 4213 extending from the third fixing portion 4211. The third elastic arm 4212 is located in the third opening 4114. The third elastic arm 4212 is provided with a third contact portion 4212a that protrudes into the third mating cavity 441 of the second receiving cavity 44. In the illustrated embodiment of the present disclosure, the third fixing portion 4211 is fixed in the third mounting groove 4101.

The fourth conductive terminal 422 includes a fourth fixing portion 4221 fixed to the second insulating block 41, a fourth elastic arm 4222 extending from the fourth fixing portion 4221 and a fourth mounting portion 4223 extending from the fourth fixing portion 4221. The fourth elastic arm 4222 is located in the fourth opening 4124. The fourth elastic arm 4222 is provided with a fourth contact portion 4222a protruding into the fourth mating cavity 442 of the second receiving cavity 44. In the illustrated embodiment of the present disclosure, the fourth fixing portion 4221 is fixed in the fourth mounting groove 4102.

In the illustrated embodiment of the present disclosure, the third contact portion 4212a and the fourth contact portion 4222a are offset from each other. The fifth side surface 4111 and the seventh side surface 4121 are distributed along a fifth direction A5-A5. The fifth direction A5-A5 is disposed obliquely with respect to the first direction A1-A1 and the second direction A2-A2.

Besides, in the illustrated embodiment of the present disclosure, the third conductive terminal 421 includes a third bent end 4215 bent outwardly from the third contact portion 4212a. The fourth conductive terminal 422 includes a fourth bent end 4225 bent outwardly from the fourth contact portion 4222a. The third bent end 4215 and the fourth bent end 4225 have opposite bending directions.

In the illustrated embodiment of the present disclosure, the third mounting portion 4213 and the fourth mounting portion 4223 are both arc-shaped and extend in a clockwise or counterclockwise direction.

The second shielding sleeve 43 protrudes into the second receiving space 30. The second shielding sleeve 43 includes a second end portion 430 and a plurality of second slits 431 extending through the second end portion 430. The plurality of second slits 431 are distributed along a circumferential direction of the second shielding sleeve 43.

Specifically, in the illustrated embodiment of the present disclosure, the plurality of second slits 431 include a fifth slit 4311, a sixth slit 4312, a seventh slit 4313 and an eighth slit 4314 which are distributed along the circumferential direction of the second shielding sleeve 43 in sequence. The second shielding sleeve 43 includes a fifth arc-shaped wall 4315 located between the fifth slit 4311 and the sixth slit 4312, a sixth arc-shaped wall 4316 located between the seventh slit 4313 and the eighth slit 4314, a seventh arc-shaped wall 4317 located between the fifth slit 4311 and the eighth slit 4314, and an eighth arc-shaped wall 4318 located between the sixth slit 4312 and the seventh slit 4313. The third arc surface 4113 of the third protruding post 411 contact an inner side of the fifth arc-shaped wall 4315. The fourth arc surface 4123 of the fourth protruding post 412 contacts an inner side of the sixth arc-shaped wall 4316. The seventh arc-shaped wall 4317 is exposed in the third mating cavity 441. The eighth arc-shaped wall 4318 is exposed in the fourth mating cavity 442. The seventh arc-shaped wall 4317 includes a third outward flange portion 4317a located at a free end of the seventh arc-shaped wall 4317. The eighth arc-shaped wall 4318 includes a fourth outer flange portion 4318a located at a free end of the eighth arc-shaped wall 4318.

When the first electrical connector 100 and the second electrical connector 200 are mated with each other, the fifth side wall 321 is received in the first receiving groove 125, the sixth side wall 322 is received in the second receiving groove 126, the third rib 3211 is inserted into the first keyway 1211, and the fourth rib 3221 is inserted into the second keyway 1221. At the same time, the first side wall 121 is received in the third receiving groove 325, the second side wall 122 is received in the fourth receiving groove 326, the first rib 1231 is inserted into the third keyway 3231, and the second rib 1241 is inserted into the fourth keyway 3241. The first terminal module 2 and the second terminal module 4 are mated with each other. The third protruding post 411 and the fourth protruding post 412 are inserted into the first mating cavity 241 and the second mating cavity 242, respectively. The first protruding post 211 and the second protruding post 212 are inserted into the third mating cavity 441 and the fourth mating cavity 442, respectively. The third contact portion 4212a of the third conductive terminal 421 and the fourth contact portion 4222a of the fourth conductive terminal 422 are in contact with the first contact portion 2212a of the first conductive terminal 221 and the second contact portion 2222a of the second conductive terminal 222, respectively, to achieve electrical connection.

Compared with the prior art, the first terminal module 2 of the present disclosure includes the first insulating block 21, the first terminal group 22 provided in the first insulating block 21 and the first shielding sleeve 23 sleeved on the first insulating block 21. The first terminal group 22 includes the first conductive terminal 221 and the second conductive terminal 222. The first conductive terminal 221 includes the first fixing portion 2211 fixed to the first insulating block 21, the first elastic arm 2212 extending from the first fixing portion 2211 and the first mounting portion 2213 extending from the first fixing portion 2211. The first elastic arm 2212 is provided with the first contact portion 2212a protruding into the first receiving cavity 24. The second conductive terminal 222 includes the second fixing portion 2221 fixed to the first insulating block 21, the second elastic arm 2222 extending from the second fixing portion 2221 and the second mounting portion 2223 extending from the second fixing portion 2221. The second elastic arm 2222 is provided with the second contact portion 2222a protruding into the first receiving cavity 24. The first contact portion 2212a and the second contact portion 2222a are offset from each other. The first shielding sleeve 23 protrudes into the first receiving space 10. The first shielding sleeve 23 is provided with the first end portion 230 and the plurality of first slits 231 extending through the first end portion 230. The plurality of first slits 231 are distributed along the circumferential direction of the first shielding sleeve 23. The present disclosure reduces the signal crosstalk by having the first contact portion 2212a and the second contact portion 2222a in the offset manner. In addition, the present disclosure improves the shielding effect on the first conductive terminal 221 and the second conductive terminal 222 by providing the first shielding sleeve 23, thereby improving the quality of signal transmission. Furthermore, the plurality of first slits 231 are distributed along the circumferential direction of the first shielding sleeve 23, so that the relevant parts of the first shielding sleeve 23 have a certain elastic deformation ability, thereby reducing the difficulty of mating with the second electrical connector 200.

The second terminal module 4 of the present disclosure has the same beneficial effects as the first terminal module 2, which will not be described again in the present disclosure.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A first terminal module, comprising:
a first insulating block, the first insulating block comprising a first protruding post and a second protruding post; the first protruding post and the second protruding post being disposed oppositely; the first protruding post being sector-shaped and defining a first opening; the second protruding post being sector-shaped and defining a second opening; and
a first terminal group, the first terminal group being provided on the first insulating block; the first terminal group comprising a first conductive terminal and a second conductive terminal; the first conductive terminal comprising a first elastic arm at least partially provided in the first opening; the first elastic arm comprising a first contact portion; the second conductive terminal comprising a second elastic arm at least partially provided in the second opening; the second elastic arm comprising a second contact portion; the first contact portion and the second contact portion being offset from each other.

2. The first terminal module according to claim 1, wherein the first terminal module comprises a first mating cavity located on one side of the first protruding post and the second protruding post, and a second mating cavity is located on another side of the first protruding post and the second protruding post;
the first contact portion protrudes into the first mating cavity; the second contact portion protrudes into the second mating cavity.

3. The first terminal module according to claim 2, wherein the first protruding post comprises a first side surface and a second side surface perpendicular to the first side surface; the first opening extends through the first side surface and is in communication with the first mating cavity; the first elastic arm is located in the first opening;
the second protruding post comprises a third side surface and a fourth side surface perpendicular to the third side surface; the second opening extends through the third side surface and is in communication with the second mating cavity; the second elastic arm is located in the second opening.

4. The first terminal module according to claim 3, wherein the first protruding post comprises a first arc surface connecting the first side surface and the second side surface;
the second protruding post comprises a second arc surface connecting the third side surface and the fourth side surface.

5. The first terminal module according to claim 3, wherein the first terminal module further comprises a first shielding sleeve sleeved on the first insulating block so as to form a first receiving cavity between the first insulating block and the first shielding sleeve; the first receiving cavity comprises the first mating cavity and the second mating cavity.

6. The first terminal module according to claim 5, wherein the first shielding sleeve comprises a first arc-shaped wall, a second arc-shaped wall, a third arc-shaped wall and a fourth arc-shaped wall; the first arc surface of the first protruding post contacts an inner side of the first arc-shaped wall; the second arc surface of the second protruding post contacts an inner side of the second arc-shaped wall; the third arc-shaped wall is exposed in the first mating cavity; the fourth arc-shaped wall is exposed in the second mating cavity.

7. The first terminal module according to claim 6, wherein the third arc-shaped wall is provided with a first outward flange portion located at a free end thereof, and the fourth arc-shaped wall is provided with a second outward flange portion located at a free end thereof.

8. The first terminal module according to claim 1, wherein the first elastic arm and the second elastic arm are disposed obliquely.

9. The first terminal module according to claim 1, wherein the first conductive terminal comprises a first bent end bent outwardly from the first contact portion; the second conductive terminal comprises a second bent end bent outwardly from the second contact portion; the first bent end and the second bent end have opposite bending directions.

10. The first terminal module according to claim 1, wherein the first conductive terminal comprises a first fixing portion fixed to the first insulating block and a first mounting portion extending from the first fixing portion; the first elastic arm extends from the first fixing portion;
the second conductive terminal comprises a second fixing portion fixed to the first insulating block and a second mounting portion extending from the second fixing portion; the second elastic arm extends from the second fixing portion;
the first mounting portion and the second mounting portion are configured to be mounted on a first circuit board.

11. The first terminal module according to claim 10, wherein the first mounting portion and the second mounting portion are both arc-shaped and extend in a clockwise or counterclockwise direction.

12. A first electrical connector, comprising:
a first insulating body, the first insulating body comprising a first base portion and a plurality of first wall portions protruding from the first base portion; the first base portion and the plurality of first wall portions jointly forming a first receiving space; and
a plurality of first terminal modules, the plurality of first terminal modules being installed to the first base portion; each first terminal module comprising a first insulating block, a first terminal group provided in the first insulating block, a first shielding sleeve sleeved on the first insulating block, and a first receiving cavity located between the first insulating block and the first shielding sleeve;
wherein the first insulating block comprises a first protruding post and a second protruding post; the first protruding post and the second protruding post are disposed oppositely; the first receiving cavity comprises a first mating cavity located on one side of the first protruding post and the second protruding post, and a second mating cavity located on another side of the first protruding post and the second protruding post;
the first terminal group comprises a first conductive terminal and a second conductive terminal; the first conductive terminal comprises a first fixing portion fixed to the first insulating block, a first elastic arm extending from the first fixing portion and a first mounting portion extending from the first fixing portion; the first elastic arm comprises a first contact portion protruding into the first mating cavity; the second conductive terminal comprises a second fixing portion fixed to the first insulating block, a second elastic arm extending from the second fixing portion and a second mounting portion extending from the second fixing portion; the second elastic arm comprises a second contact portion protruding into the second mating cavity.

13. The first electrical connector according to claim 12, wherein the first insulating block comprises a first base; the first protruding post and the second protruding post protrude from the first base.

14. The first electrical connector according to claim 12, wherein the first protruding post is sector-shaped; the first protruding post comprises a first side surface, a second side surface perpendicular to the first side surface, and a first opening extending through the first side surface and communicating with the first mating cavity; the first elastic arm is located in the first opening;
the second protruding post is sector-shaped; the second protruding post comprises a third side surface, a fourth side surface perpendicular to the third side surface, and a second opening extending through the third side surface and communicating with the second mating cavity;
the second elastic arm is located in the second opening.

15. The first electrical connector according to claim 14, wherein the first protruding post comprises a first arc surface connecting the first side surface and the second side surface;
the second protruding post comprises a second arc surface connecting the third side surface and the fourth side surface;
the first shielding sleeve protrudes into the first receiving space; the first shielding sleeve comprises a first end portion and a plurality of first slits extending through the first end portion; the plurality of first slits comprise a first slit, second slit, a third slit and a fourth slit which are distributed along the circumferential direction of the first shielding sleeve in sequence; the first shielding sleeve comprises a first arc-shaped wall located between the first slit and the second slit, a second arc-shaped wall located between the third slit and the fourth slit, a third arc-shaped wall located between the first slit and the fourth slit, and a fourth arc-shaped wall located between the second slit and the third slit; the first arc surface of the first protruding post contacts an inner side of the first arc-shaped wall; the second arc surface of the second protruding post contacts an inner side of the second arc-shaped wall; the third arc-shaped wall is exposed in the first mating cavity; the fourth arc-shaped wall is exposed in the second mating cavity.

16. The first electrical connector according to claim 15, wherein the third arc-shaped wall is provided with a first outward flange portion located at a free end thereof, and the fourth arc-shaped wall is provided with a second outward flange portion located at a free end thereof.

17. The first electrical connector according to claim 15, wherein the plurality of first wall portions comprise a first side wall, a second side wall, a third side wall and a fourth side wall, in which the first side wall and the second side wall are disposed face to face along a first direction, and the third side wall and the fourth side wall are disposed face to face along a second direction; the first direction and the second direction are perpendicular to each other;
the first protruding post and the second protruding post are disposed face to face along the second direction;
the first side surface and the third side surface are distributed along a fourth direction which is disposed obliquely with respect to the first direction and the second direction.

18. The first electrical connector according to claim 12, wherein the first mounting portion of the first conductive terminal and the second mounting portion of the second conductive terminal are both configured to be mounted on a first circuit board;
wherein the first mounting portion and the second mounting portion are both arc-shaped and extend in a clockwise or counterclockwise direction.

19. The first electrical connector according to claim 13, wherein the first base defines a first mounting groove and a second mounting groove; the first fixing portion of the first conductive terminal is fixed in the first mounting groove; the second fixing portion of the second conductive terminal is fixed in the second mounting groove.

20. A connector assembly, comprising:
a first electrical connector; the first electrical connector, comprising:
a first insulating body, the first insulating body comprising a first base portion and a plurality of first wall portions; the first base portion and the plurality of first wall portions jointly forming a first receiving space; and
a plurality of first terminal modules, the plurality of first terminal modules being installed to the first base portion; each first terminal module comprising a first insulating block, a first terminal group fixed to the first insulating block, a first shielding sleeve sleeved on the first insulating block, and a first receiving cavity located between the first insulating block and the first shielding sleeve;
wherein the first insulating block comprises a first protruding post and a second protruding post; the first protruding post and the second protruding post are disposed oppositely; the first receiving cavity comprises a first mating cavity located on one side of the first protruding post and the second protruding post, and a second mating cavity located on another side of the first protruding post and the second protruding post;
wherein the first terminal group comprises a first conductive terminal and a second conductive terminal; the first conductive terminal comprises a first fixing portion fixed in the first insulating block, a first elastic arm and a first mounting portion; the first elastic arm comprises a first contact portion protruding into the first mating cavity; the second conductive terminal comprises a second fixing portion fixed in the first insulating block, a second elastic arm and a second mounting portion; the second elastic arm comprises a second contact portion protruding into the second mating cavity; and
a second electrical connector configured to mate with the first electrical connector; the first electrical connector and the second electrical connector having same structures, but different installation angles.
